(19) United States
(12) Patent Application Publication
(10) Pub. No.: US 2003/0005413 A1
(43) Pub. Date: Jan. 2, 2003

(54) Method for testing of software

(75) Inventors: Armin Beer, Baden (AT); Joachim Manz, Munchen (DE); Stefan Mohacsi, Wien (AT); Christian Stary, Wien (AT)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Siemens AG Osterreich

(21) Appl. No.: 10/159,952

(22) Filed: May 31, 2002

(30) Foreign Application Priority Data
Jun. 1, 2001 (AT) A 861/2001

(51) Int. Cl. G06F 9/44

(52) U.S. Cl. 717/125

(57) ABSTRACT

There is provided a method for the automated testing of software, which has a graphic user interface. With at least one graphic editor, at least the dynamic and the semantic behavior of the user interface of the software is specified. Test cases are generated by a test case generator software using the thus specified behavior of the user interface, which are then executed by a software for automatic running test running either immediately or in a later step.

### CROSS REFERENCE TO RELATED APPLICATIONS

The present application is claiming priority of Austrian Patent Application A 861/2001, filed on Jun. 1, 2001.

### BACKGROUND OF THE INVENTION

1. Field of the Invention

The invention concerns a method for the automated testing of software, which has a graphic user interface, wherein a test case generator software is used that can be executed on a data processing device, by means of which test cases are generated and these are checked out with a software for automatic running of a test on a data processing device.

Furthermore, the invention concerns a method for testing of software with a graphic user interface, wherein test cases are checked out with a software for automatic running of a test on a data processing device, which are generated with a test case generator software, wherein to test a transition between two states of the user interface of the software being tested at least one test case is generated that contains the corresponding transition.

Finally, the invention also concerns a method for determining a path to a specifiable transition in an expanded diagram of state, for example, in a software with a graphic user interface. Testing is in general an activity with the goal of finding errors in a software and forming confidence for its correct mode of operation. The test is one of the most important quality assurance measures in software development. However, the test is often underestimated in terms of time, costs, and systematics in the software development process.

2. Description of the Prior Art

The design of effective test cases, i.e., such which

find customer-relevant errors,

optionally enable a more or less complete coverage of the tested object,

also contain complex test scenarios whose organization requires not only much preparation time, but also costly and hard-to-find expert knowledge, and

can also be used for automatic regression testing,

is a very demanding and time and money-consuming activity.

A test case is defined as follows by IEEE90: “A set of test inputs, execution conditions, and expected results developed for a particular objective, such as to exercise a particular program path to verify compliance with a specific requirement.” The possibility of carrying out such a demanding activity with a software tool is therefore of outstanding importance to each software development project in terms of the three known critical aspects of functionality, timeliness, and cost.

Semantic-oriented test scenarios guarantee the error-free running of the stipulated functionality in keeping with the sequences requested by the customer. The generation and executability of test scenarios through a software tool contribute significantly to meeting deadlines and also economize on development costs.

Another weakness in the release of many software projects consists in that, at the end of an often many-year development period, it is no longer transparent whether the released product can fulfill the properties which were agreed upon in the beginning and documented in the specifications. This means there is a lack of a bridge between design and test documentation, making it difficult or sometimes impossible to make accurate quality predictions about the product being delivered.

Various methods have been used for the testing of software, such as StP-T (Poston R. M., Automated Testing from object models; Comm. of the ACM, September 1994, Vol. 37, No. 9, pp. 48-58) or Rational Test Factory (Rational, User Manual, Test Factory, 1999). In these methods, however, complicated processes are running with alternate manual and automated activities.

In other software tools such as Mockingbird (Wood J., Automatic Test Generation Software Tools; Siemens Corporate Research, Technical Report 406, December 1992), it is not possible to generate any executable test cases, while in the case of the Titan Tool (Wood J., Automatic Test Generation Software Tools; Siemens Corporate Research, Technical Report 406, December 1992), test data are generated from a test scheme and test matrices. In any case, these methods are hardly user-friendly enough for successful use in complex software systems.

Various methods are also used to generate test cases, such as generation of test cases by means of search mechanisms of “artificial intelligence”, in which the backtracking mechanism of PROLOG is used. Another method consists in the generation of individual state transition sequences from a complex state transition graph with cycles from a start state to a target state, wherein the changes in state are triggered by user inputs. The drawback to these familiar methods is, in particular, that they face the problem of a large number of redundant test cases. Furthermore, there are no intelligent algorithms for the test case generation, which in addition to generating “good cases” can also generate “bad cases” and reveal specific errors.

### SUMMARY OF THE INVENTION

According to what has been said above, one object of the invention is to indicate methods by which a user-friendly testing of software is possible, and the above drawbacks are avoided.

Furthermore, another object of the invention is to enable design and testing processes even in large projects under heavy time and cost pressure.

These objects are accomplished with a method for automated testing of software as mentioned in the outset, in that according to the invention

a) at least the dynamic and the semantic behavior of the user interface of the software is specified with at least one editor, and a graphic editor is used as the editor, and

b) through the thus specified behavior of the user interface, test cases are generated by the test case generator software, which immediately thereafter or in a remote step

c) are executed by the software for the automatic test running.

Thanks to the use of a graphic editor, the behavior of the user interface of the software being tested can be specified in an extremely user-friendly way and manner.

Advisedly before step a) of the invented method, static information of the user interface is entered by the editor. Usually, the static information will be entered by a monitor screen analysis software or from a resource file.

The static information comprises at least one layout and/or attributes of the elements of the graphic user interface.

In order to allow a flexible configuration of the invented method and permit interventions by a user for the most effective possible testing, the static information with regard to the layout and/or the attributes can be amplified by a user.

The method according to the invention can be configured especially user-friendly when the dynamic behavior of the software/user interface is specified by entering status transitions, in particular, when the status transitions are represented by graphic symbols.

In this way, one has the original precise picture of a dialogue in front of them, and the individual status transitions can be defined especially easily, for example, by drawing arrows.

In an especially advantageous embodiment of the invention, the status transitions are associated with semantic conditions and/or syntactical conditions, and to specify the dynamic behavior of the user interface it is only necessary to indicate the status transitions whose events are associated with syntactical or semantic conditions.

The formal specification now present in the form of a status transition diagram describes the dynamic behavior of the user interface in exact form and is the input for a test case generator.

A test case generating algorithm searches—as will be described further below—for suitable paths in the status transition graph, wherein all elements of the graphic user interface are addressed at least once by the test case generator software and all status transitions depending on semantic and/or syntactical conditions are covered by the test case generator software with at least one correct and at least one wrong transition value.

Furthermore, the above-mentioned tasks are accomplished with a method for the testing of software as mentioned in the beginning, using a graphic user interface, in that according to the invention, in order to generate the at least one test case

a) a first path of transitions is generated, which starts with an initial status of the user interface and ends in an intermediate status, the intermediate status being a state which fulfills all entry conditions necessary for the transition being checked, and

b) at least one additional path of transitions is generated, which starts in the state generated by the transition being tested and ends in the final state of the graphic user interface, and

c) the two paths are joined together with the transition.

Advisedly, the test case generated is then stored in a test case database.

A path is generated to a given transition by a method as mentioned in the beginning, wherein according to the invention

a) at least one set of permitted input conditions is determined, for which the transition being tested can be executed,

b) suitable values are determined for all variables on which the input conditions depend, so that all input conditions are fulfilled, and for each variable on which the condition depends, starting with a first variable

c) at least one transition is sought, which sets the variable at the desired value, and then the status of the status diagram is changed to a value corresponding to the value of the altered variable and

d) step c) is carried out for the next variable of the condition.

In one embodiment of the invention, the path is determined by calling up a search function.

Favorably, no path is generated in the event that the present state of the status diagram of the user interface coincides with a set of permitted input conditions.

In an especially advantageous embodiment of the invention, the variables have a given sequence and the variables are worked off in a particular sequence per step c) and d).

Furthermore, in step c) if the value of a variable agrees with the desired value the method continues with the next variable, and if no suitable values are found in step c) an error is output.

The method according to the invention proves especially effective in that, when no transition is found for a variable, it returns at least to the immediately preceding variable that was worked off, generates a new transition for it, and then again searches for a transition for the variable per step c). Furthermore, a path is determined for each transition.

In one specific embodiment of the invention, the path is determined by recursive invoking of the search function.

Furthermore, in the event that no path to the transition is found, a different transition is determined.

Moreover, when a path is found, a check is made as to whether one or more variables already set at a desired value are changed by the path, and if at least one variable is changed by a path, a new path to the transition is sought.

Finally, if no solution is found, the sequence for working off the variables is altered, and if no solution is found in step b), different variables are sought.

In conclusion, when a path is determined it is added to an outcome path, and after all paths have been added the outcome path is output.

It is then also necessary to determine a path to an end state of the status diagram. For this, according to the method of the invention, a transition is sought which immediately terminates the application, and a path to the transition which starts from a current state of the status diagram is sought.

Advisedly, no path is sought when the current state of the application is the end state.

### BRIEF DESCRIPTION OF THE DRAWINGS

The invention shall now be explained more closely hereafter by means of the drawing. This shows:

FIG. 1 a flow chart of the method according to the invention,

FIG. 2 a sample view of a window hierarchy editor for editing the static information of a graphic user interface,

FIG. 3 a sample view of a window properties editor for editing the static information of a window of a graphic user interface,

FIG. 4 a sample view of a window editor for editing the dynamic information of a window of a graphic user interface, furthermore

FIG. 5 a view of a menu editor for editing the dynamic information of the menu of a window of a graphic user interface,

FIG. 6 a view of a condition editor for editing the semantic information of a graphic user interface, furthermore

FIG. 7 a view of an action editor for editing of semantic information of a graphic user interface,

FIG. 8 a sample input mask for generating test cases with a software tool based on the method according to the invention,

FIG. 9 a sample output window for test cases, wherein subsequent editing of the test cases is also possible,

FIG. 10 an example of an output file generated with a software for automatic test running, which has been generated by means of test cases produced with the method of the invention,

FIG. 11 an example of the generating of a test case,

FIG. 12 an example of a test case structure,

FIG. 13 an example of a structure of a function reference,

FIG. 14 an example of a condition tree,

FIG. 15 a sample view of a login window of a graphic user interface, and

FIG. 16 a structure of the function references during a sample test case generation.

### DESCRIPTION OF THE INVENTION

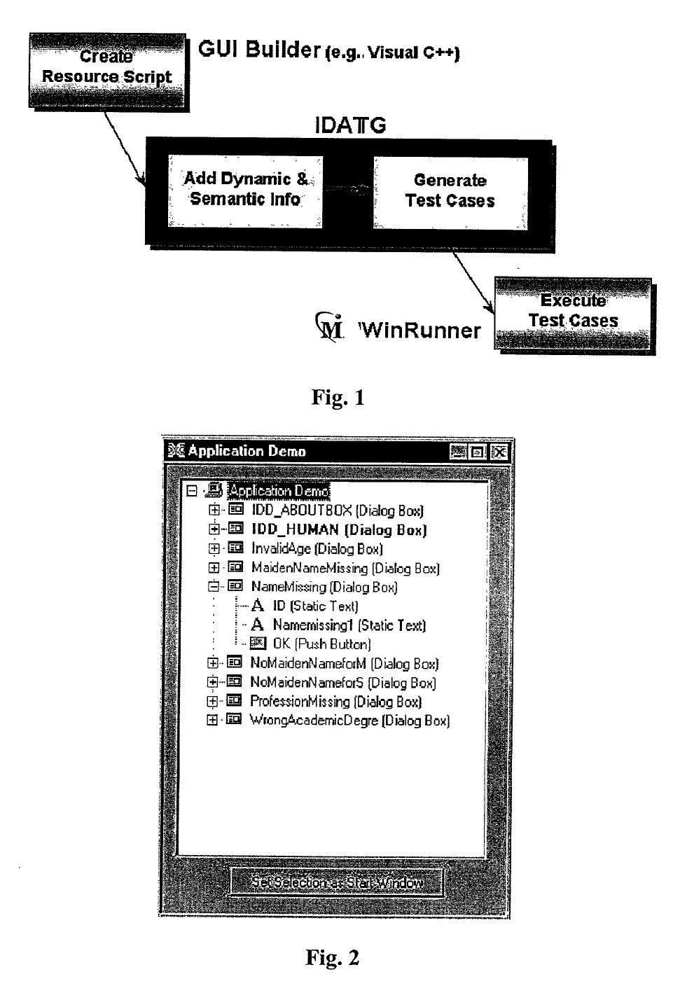

Hereinafter, the invented method and a software adapted appropriately to carry out the method are explained in detail by means of FIGS. 1-16. FIG. 1 shows the basic sequence of the method, the portion critical to the invention being designated as IDATG. According to FIG. 1, first of all a graphic user interface (GUI) being tested is described in terms of its static properties, for example, using an appropriate software, such as a so-called “GUI Builder”. This static information is then saved in a resource file. Another possibility is to determine the static information by means of monitor screen analysis software (“GUI Spy”). A detailed explanation of the static structure of a GUI will be given further on.

The static information saved in the resource file or entered with the monitor screen analysis software is now read into the IDATG software used according to the invention, amplified with the dynamic and semantic information about the GUI, and by means of all this information, as is further explained in detail hereinafter, test cases are generated, which can ultimately be executed with a corresponding program, such as “WinRunner”.

FIGS. 2-8 show various editors and dialogue windows for describing the graphic user interface, which we shall explain in detail hereafter. For subsequent editing of the static information of the GUI, a window hierarchy editor is used, as shown by example in FIG. 2, in which the window hierarchy of the GUI is indicated as a tree. This hierarchy can then be worked on with the editor by means of Drag and Drop.

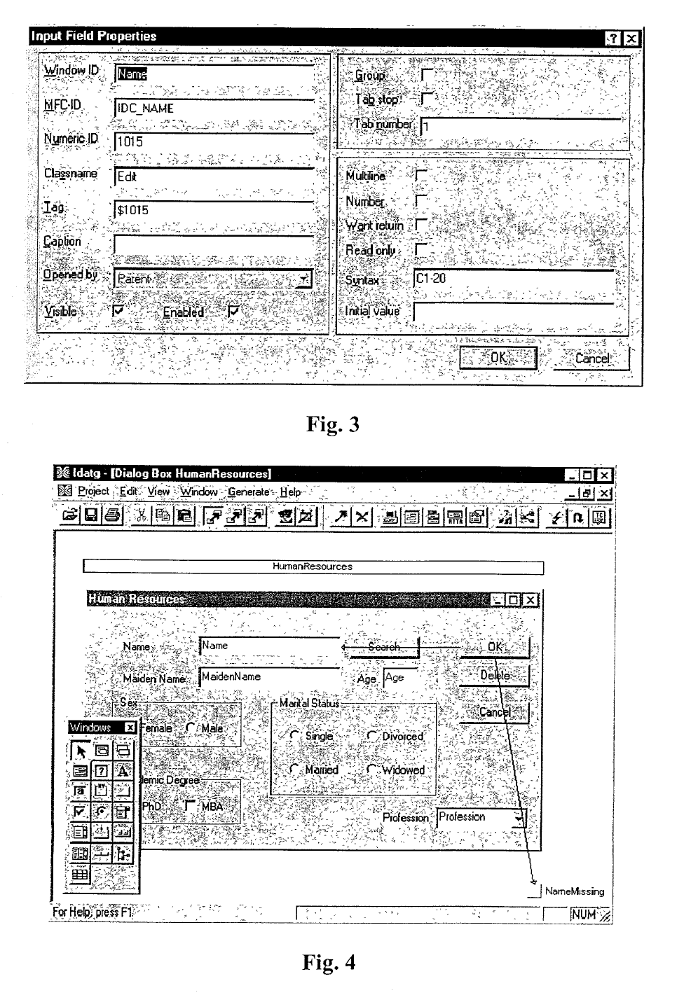

FIGS. 3 and 4 show a window properties editor for editing the static information of a window of a graphic user interface, as well as a window editor for editing the dynamic properties of a window of the graphic user interface. The dynamic behavior of the OK button is described with the arrows of the graphic editor shown in FIG. 4. If the user input is correct, the focus jumps back to the first field, in this case, “Name”, and a new person can be entered with the corresponding data in the input mask. If, instead, a wrong input is made, such as a negative age in the “Age” field, a corresponding message is output in an error message window.

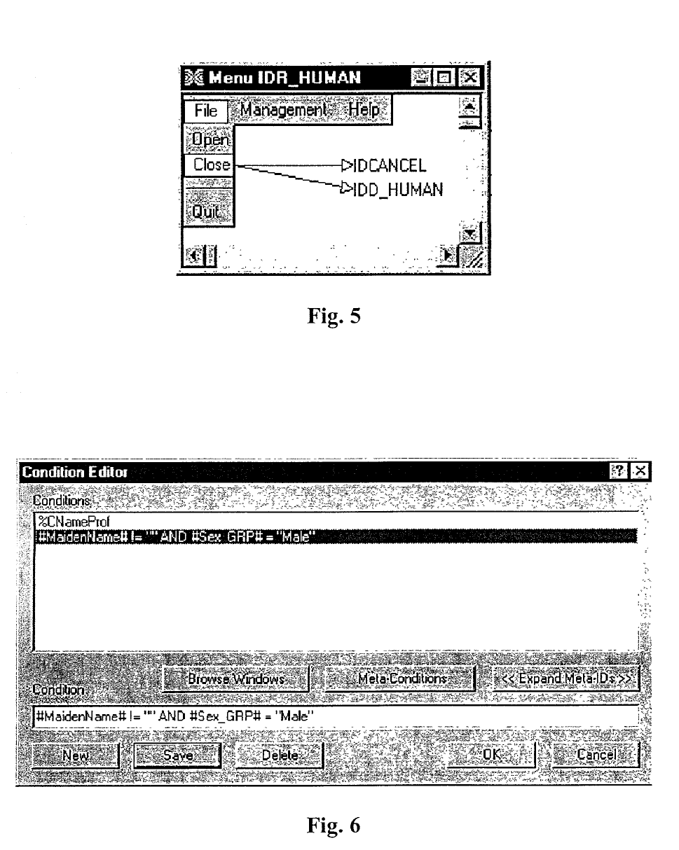

With the menu editor shown in FIG. 5, menus of a GUI can be edited, and transitions can be indicated and triggered by selecting the corresponding menu entry (in the depicted example, by selecting “Close” a file is closed and there is a branch going to different windows depending on whether or not the file was previously edited).

With the condition editor shown in FIG. 6, yet additional semantic information can be edited, e.g., that the indicated gender must not be male when a maiden name (#MaidenName#) is entered.

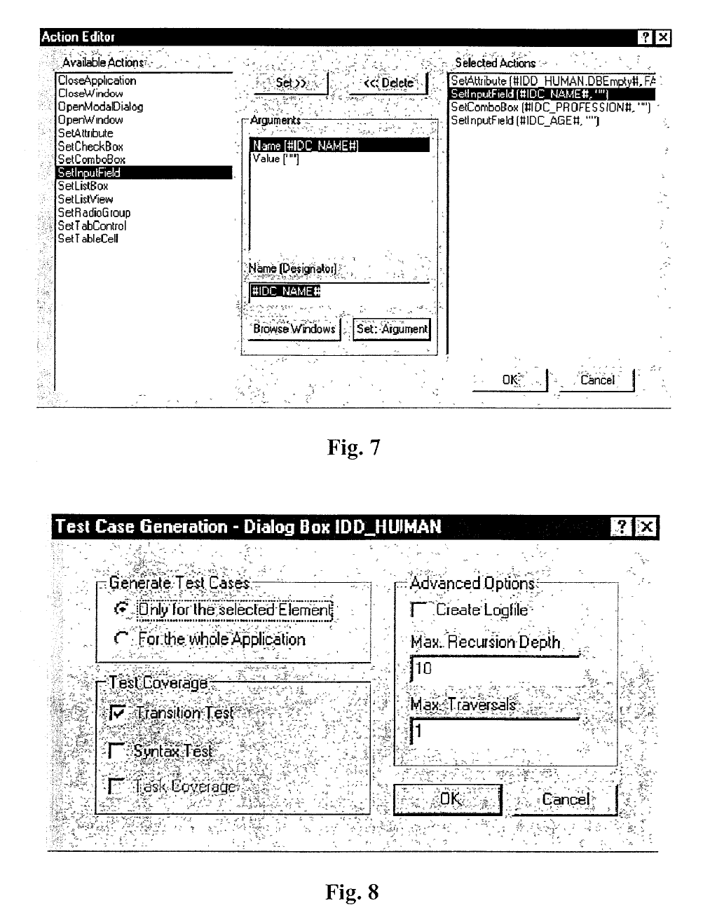

FIG. 7 shows an actions editor, which shall be discussed further below, and FIG. 8 shows a typical selection window for the software used, revealing that two types of test cases can be generated in a well-proven embodiment of the invention, namely, a transition test for transitions between particular transitions, and a syntax test for input fields.

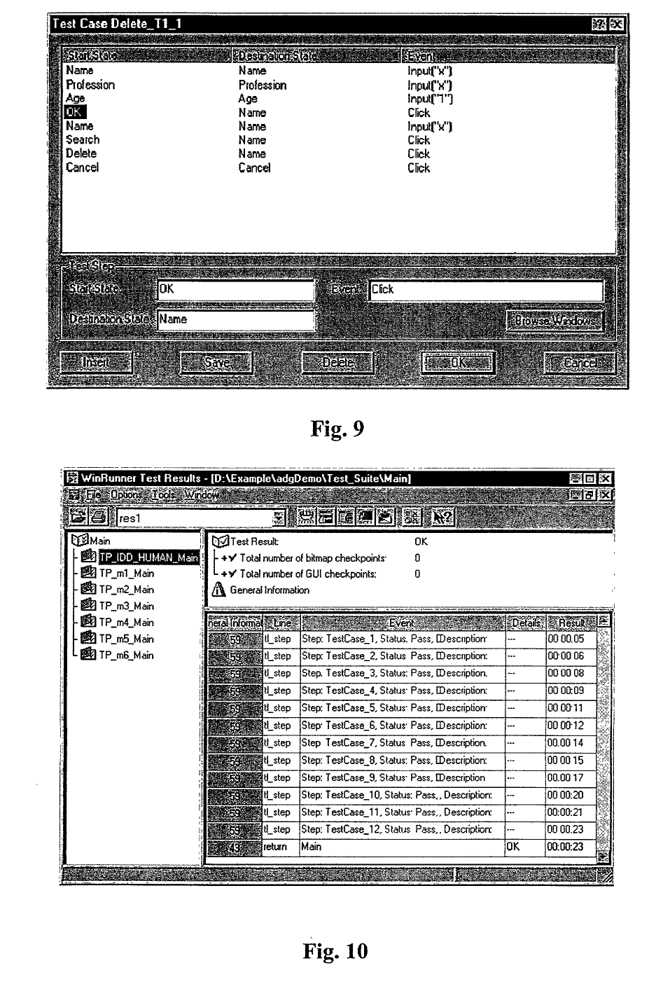

Finally, FIG. 9 shows an output editor for generated test cases, with which the test cases can be further edited afterwards and certain additional test cases, such as manually created ones, can also be added, and FIG. 10 shows the outcome of a test run with an automatic testing software—such as WinRunner—using test cases generated by the method of the invention.

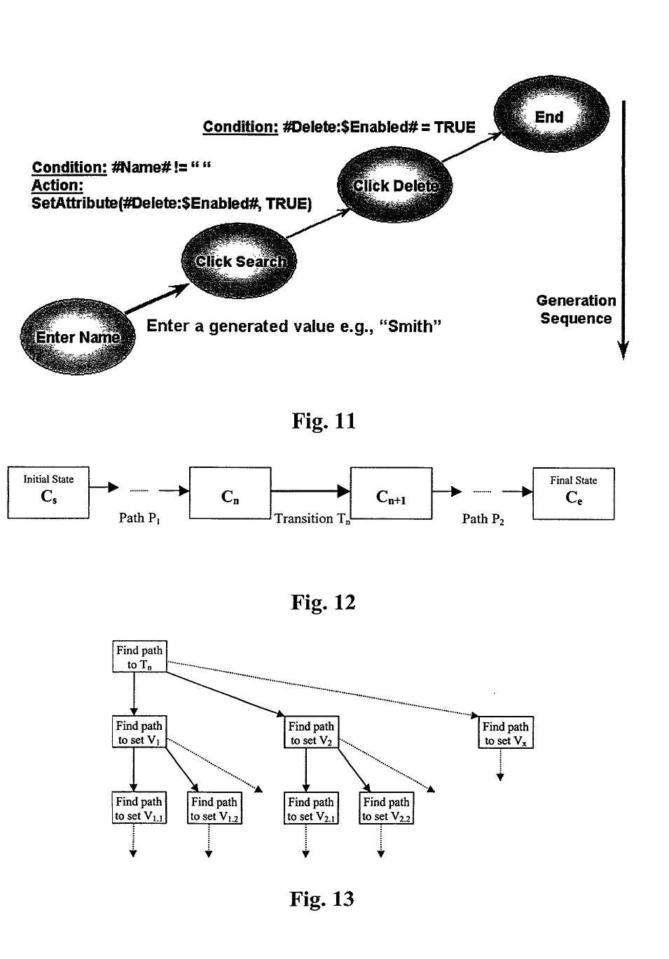

A simple example of the generating of a test case is shown in FIG. 11. The purpose of the test case is to test the “Delete” button of an application. However, this is only active when a data record has previously been sought by “Search”. The searching, in turn, is only possible when a name has previously been entered as the search term. All this information is specified in advance as conditions and actions. The generating algorithm is able to create a correct test case step by step from this information.

For a better understanding of the invention, a graphic user interface shall now be described by means of formal terminology.

Graphic user interfaces consist of objects, the so-called “Windows”. There are various definitions for the term “Window”. In the following description, all GUI objects shall be termed “Windows”, i.e., dialogues, buttons, input fields and even static text will also be designated as windows, regardless of the actual position of the window in the hierarchy of the graphic user interface. Each window is assigned a distinct ID. Thus, a graphic user interface can be described as a set of windows: GUI_Objects={W₁, W₂, . . . Wₙ}, with the Wᵢ representing the corresponding window IDs.

Each window can be described by a set of properties, termed hereinafter “designators” and always enclosed by a ‘#’ character. One can distinguish three basic types:

Designators already defined by the class library of the GUI. These include strings such as the ID or the caption, numbers like the coordinates, and Boolean values which indicate whether the window is active or not. The names of these designators have the following pattern: #WindowID:$PropertyName#. For example, #IDOK:$Enabled#. The character ‘$’ is used to distinguish predefined designators from other types.

Many window types accept user input, which is indicated as the window contents. For example, input fields can contain strings or numbers, check boxes can contain Boolean values. The window ID is sufficient to address these values, e.g., #IDC_NAME#.

In addition, a user can define additional designators for a window, in order to describe certain application-specific properties. For example, a dialogue can have different modes, such as one mode for creating a new data record and another mode for editing an existing data record. In this case, it is convenient for the user to define a new Boolean designator which indicates the present mode, for example. The following pattern is used as the syntax in this case: #WindowID:PropertyName#. For example, #IDD_HUMAN:Mode#. In this case, the property name contains no ‘$’.

A window W is now defined by a n-tuple of designators (properties): W=(D₁, D₂, . . . Dₙ). The number and the types of the designators depend on the class library used for the GUI and other application-specific properties. This n-tuple of designators describes a momentary condition, since the values of the designators can change dynamically when the application is executed. For example, a user can change the contents of a window or its size.

Since the GUI consists exclusively of windows and each state can be represented by a tuple, the entire status of the GUI can also be described as a combination C of all these tuples:

C=(W₁, W₂, . . . Wₙ)=(D_{1,1}, D_{1,2}, . . . D_{1,m}, D_{2,1}, D_{2,2}, . . . D_{2,p}, D_{n,1}, D_{n,2}, . . . D_{n,q}).

The initial state of the GUI is termed the starting combination Cₛ, it contains all initial values of the GUI designators.

When the GUI application is terminated, no more windows exist, the end combination is empty: Cₑ=( ).

Static Structure of a GUI

Each window of a GUI can have an unlimited number of so-called “child windows”. On the other hand, each “child window” has precisely one “parent window”, or in the case of a top-level window, no parent window. The father-child relation R between two windows with IDs p and c can be defined as follows: pRc, wherein p is the parent window of c. Cycles such as R={(a, b), (b, c), (c, a)} are not permitted. Thus, the windows of a GUI are arranged hierarchically in the form of a tree. Actually, it is more of a forest than a tree, since several subtrees can exist, which are not connected to each other.

The semantic connections of a parent-child relation are as follows: a child can only exist if its father also exists. Likewise, a child can only be activated if the father is also activated. On the other hand, of course, the father can exist without the existence of the child being necessary. Moreover, it is not possible for a child to dynamically alter its father.

Behavior of a GUI

By the use of combinations, the behavior of a GUI can be expressed as a machine of finite states (state automaton). It must be realized, however, that the number of possible states, even for small GUls, can be very large and thus makes it practically impossible to be represented in an ordinary state transition diagram. For this reason, it is necessary to make certain amplifications to the concept of a state automaton in order to handle this complexity.

In the preceding paragraphs, the description of the momentary states of a GUI has been explained. In addition, it is also necessary to describe the changes in state that occur during the running of a GUI. These changes in state are termed transitions (T) and are triggered by a user input or an internal event. A transition is a 3-tuple T=(E, S, τ), which comprises

the event E which triggers the transition,

a set S of correct (valid) input combinations for this transition, and

a function τ(C)→C, which is defined for each valid input combination.

This transforms the input combination into a new combination.

### EXAMPLE

When the user presses the OK button (event is triggered) and all fields are properly filled (definition of correct input states), the input focus should go back to the first input field (definition of the transformation function).

Instead of listing all valid input combinations, it is usually easier to describe the valid set of correct input functions by means of conditions. Accordingly, a combination is valid for a particular transition when all conditions are fulfilled for the transition of the values of the designators in the combination. Otherwise the combination is invalid. Usually not all designators have direct influence on the condition.

### EXAMPLE

the condition #IDOK:$Enabled#=TRUE refers only to a single designator of the combination, the other values are irrelevant. Thus, all combinations for which #IDOK:$Enabled#=TRUE are valid.

Likewise, most transition functions do not impact all values of the input combination. Thus, a function can be expressed more easily by the number of elementary value changes which are termed “actions”. For example, the action SetAffribute(#IDOK:$Enabled#, TRUE) affects only one designator of the combination. In many cases, the designators depend on each other, which means that when a designator is set at a new value, one or more other designators are also set at a new value. For example, if a window is closed, all of its children are also closed.

Special languages are necessary to describe events, conditions and actions. These are explained in detail hereafter.

Event Language

Each transition is triggered by an event. A transition will then be executed only when the event occurs and all conditions for the transition are fulfilled. Thus, an event can be considered a precondition for a transition. The difference from the other conditions is that events are momentary (they have no duration), while other conditions are present for a particular duration.

The events which can occur for a GUI can be divided into two groups:

Events which are triggered by a user, for example, by a mouse click or by pressing a key of the keyboard

Events which are triggered by the system, such as the signal of a clock or an internal message.

Both types depend heavily on the hardware and software of the system being tested, for example, the layout of the keyboard or the operating system. Therefore, it is hardly possible to develop a language which can describe all possible events of a computer system. The language developed for the software used in the context of the invention (IDATG) covers all keyboard and mouse events which are executed by a user on a personal computer under MS Windows®, yet it can be easily adapted to other systems.

Each user event refers to a particular window, for which the event is intended. The fundamental syntax for the description of an event is Event/WindowID. For example, <MClickL>/IDOK designates a click of the left mouse button, while the mouse cursor is positioned above the OK button. If no window ID is specified, the software of the invention assumes that the affected window is the one in which the entry focus is located at the moment. (This information is contained in the input combination of the transition.)

The event language makes no distinction between upper and lowercase (<MClickL> and <mclickl> mean the same thing). However, it is important to use the correct notation in string constants which occur in the tested application (i.e., <select“ListItem”> does not mean the same as <select“listitem”>). A transition without a triggering event may be necessary in rare cases and will be expressed as < >.

Events triggered by the keyboard have the following syntax in the invented software: if the key name has a length of more than one character, it must be indicated in angle brackets, for example <Enter>. Groups of keys to be pressed at the same time are enclosed in the same angle brackets and are separated by hyphens, such as <Ctrl-Shift-F10>.

A more detailed presentation will not be given here, since it is not very important to the concept of the invention, and only a few other examples shall be given here, namely

Functions and cursor keys:

<Esc>, <F1>-<F12>, <PrtScr>, <ScrlLock>, <Pause> <Ins>, <Del>, <Home>, <End>, <PgUp>, <PgDn> <Left>, <Right>, <Up>, <Down>

important keys of the main keyboard:

<Backspace>, <Tab>, <CapsLock>, <Enter>, <Space> <Divide>(/), <Minus>(−), <Greater>(>), <Less>(<)

special keys (normally the plain name is enough. If it is important whether the right or left key is pressed, L or R will be added):

<Shift>, <ShiftL>, <ShiftR> <Ctrl>, <CtrlL>, <CtrlR> <Alt>, <AltL>, <AltR>, <AltGr> (on German keyboards) <Win>, <WinL>, <WinR>, <Menu> (additional keys, e.g., for Win95/98);

Events triggered by the mouse are likewise written in angle brackets:

| | |
|---|---|
| <MClickL> | Click with left mouse key |
| <MClickR> | Click with right mouse key |
| <MDblClickL> | Double click with left mouse key |
| <MDblClickR> | Double click with right mouse |
| | key |
| <MPressL> | Press and hold down the left |
| | mouse key |
| <MPressR> | Press and hold down the right |
| | mouse key |
| <MReleaseL> | Release the left mouse key |
| <MReleaseR> | Release the right mouse key |
| <MMove> | Move the mouse |

Condition Language

Conditions are necessary to define a set of valid input combinations for a transition. Such a set of valid input combinations is defined implicitly by a specifying of certain restrictions on some or all designators in the combination, which limits the set of possible GUI states to those states which are valid for the transition. We shall now briefly discuss the necessary syntax for the description of such conditions.

In the software used according to the method of the invention, both upper and lowercase letters are accepted, and spaces can but need not be used between operators and operands. Likewise, brackets can be used, but they are only necessary to alter the priority of the operators.

The language obeys the mathematical and logical rules of priority. Expressions are written in “infix” notation, which means that binary operators stand between their two operands and unary operators stand in front of their operands. Conditions must always yield a Boolean value, since conditions can only be TRUE or FALSE.

The language of the software used (IDATG) recognizes four basic types of value, namely:

| | |
|---|---|
| NUM | an integer value (32 bits) |
| BOOL | a Boolean value, which can be TRUE or FALSE |
| STRING | a string (maximum length = 255 characters) |
| DATE | a valid date in format DD.MM.YYYY |

Operators which are accepted by the software can be divided into four classes:

Logical operators

IDATG accepts the standard operators AND, OR, XOR and NOT. OR signifies an inclusive Or, which yields TRUE if at least one of its operands is TRUE; XOR is an exclusive Or, which yields TRUE when only one operand is TRUE and the other is FALSE.

Comparison operators

Operands can be compared by using the operators =, !=, <, >, <= and >=. While the last four operators are only permitted for numerical expressions and date entries, the equal (=) and the unequal (!=) signs are used for all data types. The software automatically decides whether a mathematical or a string comparison is being done.

Numerical operators

The basic operators +, −, * and / can be used.

Special operators

The operator SYN checks whether the present content of a field corresponds to the specified syntax of same or not. The operator expects the ID of the input field as the argument. For example, if the syntax C2 (2 characters) is defined for the input field IDC_NAME, then the expression SYN #IDC_NAME# yields TRUE if the field contains, say, “ab”, and FALSE if it contains “abc”.

Furthermore, there are three different types of operands:

Constant values: the notation depends on the type of value. NUM values are written as usual (45, −3), BOOLEAN values can be TRUE or FALSE. STRING values are written between quotation marks (“text”, “Jerry Steiner”). A backslash (\) ensures that the next character is interpreted as text (e.g., “te\“xt”). DATE values are written as DD.MM.YYYY (e.g., 08.03.1994, 29.02.2000).

Designators (variables): designators can be addressed by writing the corresponding name between ‘#’ characters (e.g., #IDC_NAME#). It is important that each variable have exactly the type which the particular operator requires. For example, it is not possible to compare the designator #IDOK:$Enabled# (BOOL type) with the constant value 5 (NUM type).

Compound expressions: there are no limitations on the complexity of expressions; accordingly, it is possible to use operands which are compound expressions and themselves contain operators. For example, the BOOLEAN expression ‘#IDC_NAME#=“Mr. Holmes”’ can be used with every logical operator and ‘(#IDC_AGE#*3)+5’ with every numerical one.

Action Language

Actions are used to define the transition function which transforms an input combination into an output combination, for which an action editor such as that shown in FIG. 7 is used. The simplest possibility for specifying such a function is to define a set of fundamental actions, which each alter an individual designator of the combination. For example, SetAttribute(#IDOK:$Enabled#, TRUE) alters only the Boolean designator #IDOK:$Enabled#.

However, it is often more comfortable to specify more complex actions, which produce a changing of more than one designator. These actions depend on the functionality of the GUI class library used, since they must describe typical processes of the GUI. For example, the action CallDialog(#IDD_HUMAN#) not only sets the designator #IDD_HUMAN:$Exist# at TRUE, but also the $Exist designator of all children of the dialogue. In this case, it is obviously more simple to define a single action, instead of defining an individual action for each child window.

In addition, it is also important to define the sequence in which the actions are to be executed, since it is possible that two actions will determine the value of one and the same designator. Furthermore, it is possible for one action to depend on an outcome of a previous action.

Basically, each action has a distinct name and expects a particular number of arguments, very similar to a function reference in a programming language. Arguments must agree with the prescribed type and can be any expression covered by the condition language. In this way, it is possible to make reference to designators with action arguments or to use complex expressions. Example: SetCheckBox(#IDC_PHD#, NOT #IDC_MBA#), SetInputField(#IDC_AGE#, 5*3+4).

In summary, we can say that the following information is necessary for the formal description of a GUI: a set W, which contains all windows of the GUI, a start combination Cₛ, which defines the starting condition for all properties of the windows in W, a binary relation R on W, which describes the mother-child relationship between the windows, and a set of transitions T, which describes the dynamic behavior of the GUI. Thus, a GUI can be formally written as GUI=(W, Cₛ, R, T).

Algorithm for Generating the Test Case

Test Case Generation

The following section discusses a possible application of the formal GUI specification language, namely, test case generation.

An ordered sequence of transitions P=(T₁, T₂, . . . Tₙ) is termed a path (P) when the following conditions are fulfilled:

∀ i≧1: i≦n τᵢ(Cᵢ)=Cᵢ₊₁: Cᵢ ε Sᵢ (each transition produces a combination representing a valid input for the next transition). Cₙ₊₁ is the output combination of the path. Thus, the path can also be considered a meta-transition with the function φ(C₁)=Cₙ₊₁=τₙ(τₙ₌₁( . . . (τ₂(τ₁(C₁))))).

A path is termed a test path (TC) if it begins in the starting state of the GUI and ends in the end state of the GUI, which means that the application is terminated. TC=(T₁, T₂, . . . Tₙ), C₁=Cₛ, Cₙ₊₁=Cₑ. The goal of the test case generation (TCG) is to find a set of test cases which covers all specific transitions and, thus, the entire GUI. In order to test a special transition, one needs an algorithm to find test cases which contains this special transition.

Finding a Test Case for a Particular Transition

Two paths need to be found in order to find a test case which contains a special transition Tₙ=(Eₙ, Sₙ, τₙ):

A path P₁=(T₁, T₂, . . . Tₙ), which begins in the starting state of the GUI and ends in a valid input state for the transition being tested. C₁=Cₛ, Cₙ ε Sₙ. The path can be empty if Cₛ ε Sₙ.

A path P₂=(Tₙ₊₁, Tₙ₊₂, . . . Tₘ), which begins in that state which is generated by the transition being tested, and which ends in the end state of the GUI. Cₙ₊₁ ε Sₙ₊₁, Cₘ₊₁=Cₑ. The path is empty if Cₙ₊₁ =C_{c}.

This situation is represented in FIG. 12. Thus, the generation algorithm works as follows (in pseudo-code):

Function GenerateTC (Input: Transition Tₙ)

Initialize the GUI variables corresponding to Cs. Note: the state of the tested GUI is simulated by these variables.

Search for the first path P₁ by invoking the function SearchPathToTrans(Tₙ, Cₛ)

If no path is found, an error is output (inconsistent specification)

Search for the second path P₂ by invoking the function SearchPathToEnd(Cₙ₊₁)

If no path is found, an error is output (inconsistent specification)

Finding a Path to a Particular Transition

The function SearchPathToTrans tries to find a path P₁ which begins in the starting state of the GUI and ends in a state which permits the execution of the special transition Tₙ. Many graph search algorithms begin from a starting state of the system and try to reach the desired state via random paths. The enormous number of possible combinations and user inputs, however, make it impossible to arrive at an outcome in a reasonable time when using this technique. Thus, one needs an algorithm such that one can systematically achieve a particular state in which all conditions for this state are fulfilled one after the other.

Function SearchPath To Trans (Input: Transition Tₙ, present GUI state Cᵢ)

1. Determine the set of valid input combinations Sₙ, or in other words, the conditions which must be fulfilled in order to execute Tₙ

2. If Cᵢ ε Sₙ, no path is necessary=>successful completion

3. Search for suitable values for all variables on which the condition is dependent, so that the condition becomes TRUE. This can be accomplished by invoking the function FulfillCondition(Sₙ, TRUE).

4. If no solution is found, an error is output

5. The following is performed for all variables on which the condition is dependent:

{

6. If the present value of the variable agrees with the desired one, the method continues with the next variable

7. Search for a transition Tₓ, which sets the variable at the desired value

8. If no transition is found, backtracking is commenced, returning to the preceding variable

9. Recursive invoking of SearchPath To Trans(Tₓ, Cᵢ) in order to find a path to Tₓ

10. If no solution is found, search for another transition by jumping back to step 7

11. Check to see whether the new path alters variables which were already set in an earlier run-through

12. If so, search for a new path by jumping back to step 9

13.Add the new path to the outcome path, set Cᵢ appropriately and continue with the next variable

}

14. If no solution was found, an attempt is made to alter the sequence of the variables or find other suitable variables by jumping back to step 3

15. Output of the outcome path

As can be seen, the algorithm uses backtracking, i.e., returning to an earlier program state if no solution could be found. Furthermore, if the function delivers an unsuitable outcome, the function can be invoked again to output an alternative solution. This can be repeated until no more alternative solutions exist.

Another property of the algorithm is its complex recursive structure. Unlike conventional recursive functions, which produce a linear sequence of function references, the structure of the function references in this algorithm resembles a tree, as shown in FIG. 13. Each instance of the function starts a recursion for each variable that needs to be set. The recursion ends when no path is required to set the variables, because these variables already have the correct value. The resulting path can be determined by joining together the leaves of the tree from left to right.

Backtracking in combination with the treelike recursion structure makes it exceptionally difficult to follow the generation process. For this reason, a logging technique should be used, which writes information about the process into a logfile.

Furthermore, suitable measures must be adopted to avoid infinite recursions. First, the maximum recursion depth can be limited with a simple counter. When the limit is reached, the function SearchPath To Trans outputs an error. Secondly, the number of occurrence of a particular transition in a path can be limited. The limit is checked after searching for a transition in step 7. If the limit is reached, the transition is rejected and an alternative is sought.

Finding a Path to the End State

After SearchPath To Trans has returned a path P₁, which begins with the starting state of the GUI and ends with the desired transition Tₙ, it is necessary to find the test case by discovering a path P₂ from Tₙ to the end state Cₑ of the GUI. This goal can be achieved by the function SearchPath To End, which is basically a simplified version of SearchPath To Trans.

Function SearchPathToEnd (Input: status of the GUI Cₙ₊ᵢ)

1. If Cₙ₊₁=Cₑ, no path is necessary=>successful completion

2. Search for a transition Tₓ which ends the application

3. If no transition is found, an error is output (inconsistent specification)

4. Invoke the function SearchPath To Trans(Tₓ, Cₙ₊₁) to find a path to Tₓ

5. If no solution is found, a new transition is sought by jumping back to step 2

6. Output of the outcome path

Fulfillment of a Condition

In order to find a path to a particular transition, one needs to know how the condition on which the transition depends can be fulfilled. This means that a suitable value has to be found for all variables occurring in the condition, so that the condition is fulfilled.

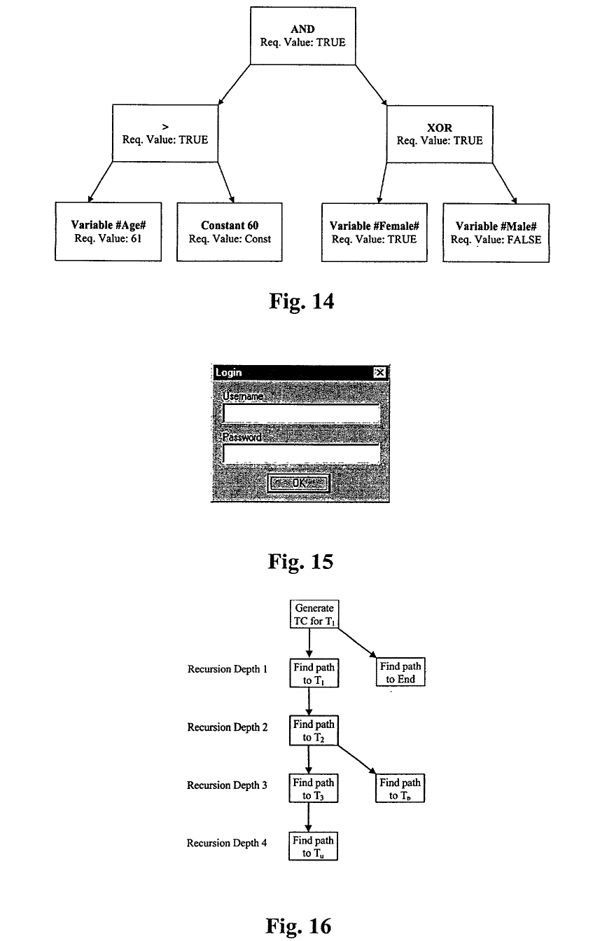

A condition can be represented as a tree, with operands representing child-nodes of its operators, as is shown for example in FIG. 14. Once again, a recursive algorithm which uses backtracking is used to find solutions for this condition tree.

The heart of the algorithm is the procedure FulfillCondition(nodes, value). This is called up recursively for each node of the condition tree. The input parameters are the present node and the required value for the subexpression represented by this node. The algorithm can be started by calling up the function FulfillCondition(RootNode, “TRUE”). Each node tries to furnish the value required of it by requiring suitable values from its child-nodes. Depending on the type of node, different strategies are used to fulfill the desired condition. The recursion ends at the leaf nodes of the tree, which are either constant values or variables. While constant values cannot be changed to fulfill a condition, it is of course possible to assign new values to variables.

As an example, take the condition (#Age#>60) AND (#Female# XOR #Male#) for an entry in a data form; this situation is represented by the condition tree in FIG. 14. The tree is worked off from top to bottom as follows:

The root node ‘AND’ is invoked with the required value ‘TRUE’. In order to fulfill the condition, it likewise requires the value ‘TRUE’ from its child-nodes.

The left child-node ‘>’ checks whether one of its own child-nodes has a constant value. Since its right successor always returns 60, the only way to fulfill the condition (#Age#>60) is to require a suitable value (e.g., 70) from its left successor.

The nodes #Age# represents the content of an input field and is now set at the value 70. If this value proves unsuitable in the course of the test case generating, and backtracking is initiated, the parent-node tries the same procedure with other possible values such as 61, 1000, 10000 etc. Only if all these attempts fail does the parent-node also output an error.

The node ‘XOR’ (exclusive or) has two possibilities of fulfilling the condition, since both children-nodes do not have a constant value. First, it attempts to require ‘TRUE’ from the left node and ‘FALSE’ from the right branch. If this does not lead to the desired success, the desired values are reversed.

The nodes #Female# and #Male# represent the values of two check boxes. Very similar to the input field #Age#, their values are set by the parent-node.

If all nodes have succeeded in furnishing the required values, the source-node finally returns a success message to the calling function.

If a variable occurs more often than once in a condition, semantic contradictions need to be avoided. Thus, e.g., the value 70 would be invalid in a condition like (#Age#>60) AND (#Age#<65). In this case, the following occurs:

The value of #Age# is set at 70 by the first subtree (#Age#>60)

The second subtree (#Age#<65) determines that the value of #Age# has been set by another node and that this value is not suitable to fulfill the condition. An error is output.

Backtracking is started and the first subtree tries to find a different value (e.g., 61)

Now the condition of the second subtree is also fulfilled and the function is successfully ended.

Often it is also desirable to generate test cases which do not fulfill certain conditions. The goal of such a procedure is to test how the GUI will respond to wrong user input. This goal can be accomplished in simple fashion by requiring ‘FALSE’ instead of ‘TRUE’ from a condition node.

Case Study

In this section, the methodology for representing a GUI and the subsequent test case generation will now be explained by a simple example. In practice, a large amount of the following described formalism remains hidden from the user, since the invented software provides powerful visual editors for the description of the GUI. We shall assume that it is necessary to specify and test a login window (see FIG. 15).

At first, we need the definition of the GUI object, i.e., the set of windows: W={LoginDialog, Username, Password, OK}. The abbreviations {L, U, P, O} shall be used for these hereafter. In order to describe these windows, the following designators are necessary:

For all window types: (Caption [String], Enabled [Boolean], Visible [Boolean], Focused [Boolean], coordinates [4 integers]).

In addition, the two input fields U and P have a designator Value [String].

In the software being used, information about the window layout can be advantageously put in from resource files or using a “GUI Spy”.

As the next step, it is necessary to define the starting status of the GUI by establishing the starting value of each designator.

L=(“Login”, TRUE, TRUE, TRUE, 0,0,139,87)

U=(“Username”, TRUE, TRUE, TRUE, 7,16,132,31,“”)

P=(“Password”, FALSE, TRUE, FALSE, 7,45,132,60,“”)

O=(“OK”, FALSE, TRUE, FALSE, 43,67,93,81)

As is evident, P and O are initially enabled and the focus is at U (and also at L, which is the child of U).

Now a starting combination can be defined by linking up all the designators:

Cₛ=(“Login”, TRUE, . . . 43,67,93,81).

As already mentioned above, this information can be imported in the software which we are using or be manually edited with the properties editors.

Furthermore, the parent-child relations are also required, which are relatively easy in this “little” application: L is the mother of U, P and O. R={(L, U), (L, P)<(L, O)}.

In the software used, the parent-child relations are visualized and edited in a tree view.

Furthermore, it is also necessary to describe the dynamic behavior of the GUI. For this, the transitions which can occur in this sample application are specified. However, a considerable portion of the behavior of the GUI is already defined by the platform used and the window type, and therefore we shall only go into those transitions which represent additional GUI properties that are implemented by a programmer.

The first transition T₁ describes the behavior of the OK button. The event is a mouse click on OK:

E₁=<MClickL>/#O#

The set of possible input combinations is defined by the following conditions:

S₁=#O:$Enabled# AND #O:$Visible#

The transition is described by the following action:

τ₁=CloseApplication( )

As can be noticed, the OK button has to be enabled before it can be activated. One must now specify how it can take on this value.

The transition T₂ describes the “Password” field: the event is left open, since there is no corresponding event here that would have the meaning “enter a value into the field”. One could only define an event if a special value were used for P. Yet this implies that only that special value can be entered in the field, which is not the case. In order to solve this problem, namely, the fact that any given value can be entered, the following notation is used:

E₂=< >

S₂=#P:$Enabled# AND #P:$Visible# AND #P# !=“”

After a password has been entered, the OK button is enabled:

τ₂=SetAftribute(#O:$Enabled#, TRUE)

Finally, we also have to specify how P can be enabled: the transition T₃ refers to the behavior of the “Username” field. Again, the event is described indirectly through the following condition:

E₃=< >

S₃=#U:$Enabled# AND #U:$Visible# AND #U# !=“”

After a username has been entered, P is enabled:

τ₃=SetAttribute(#P:$Enabled#, TRUE)

Keep in mind that it is not possible to specify which username and which password will actually be accepted by the application, since this information is saved in a database and changes dynamically. However, sufficient information now exists to generate a sample test case for a GUI. After the generation, the tester can either replace the generated values with actual values from a database, or he can place these values in the specification of the GUI as E₂ and E₃.

Generation of a GUI Test Case

The generating of the test case for T₁ will now be demonstrated, thereby furnishing an approximate idea of the difficulties even with simple GUIs. The generation is rather cumbersome, even though only a few transitions occur and no backtracking is necessary. FIG. 16 shows the structure of the function references for easier understanding:

Function GenerateTC(T₁)

Initialize the GUI variables per Cₛ

Seek the path P₁ by calling up the function

SearchPathToTrans(T₁, Cₛ)

Function SearchPathToTrans(T₁, Cₛ)

[Recursion Depth 1]

1. Determine the set of permitted input combinations SI =#O:$Enabled# AND #O:$Visible#

2. Cₛ ∉ S₁=>a path is necessary

3. Seek suitable values for all variables by invoking the function FulfillCondition(S₁, TRUE)

4. The function outputs a solution: #O:$Enabled# and #O:$Visible# require the value TRUE

5. The following is now performed for both variables:

{

(First loop for #O:$Enabled#):

6. The present value of the variable (FALSE) does not coincide with the necessary value (TRUE)=>a prior path has to be sought, which sets the variable

7. A suitable transition is sought

8. A solution is found: T₂ activates O!

9. Recursive invoking of SearchPath To Trans(T₂, Cₛ) to find a path to T₂

Function SearchPathToTrans(T₂, Cₛ)

[Recursion Depth 2]

1. Determine the set of permitted input combinations S₂=#P:$Enabled# AND #P:$Visible# AND #P# !=“”

2. Cₛ ∉ S₂=>a path is necessary

3. Seek suitable values for all variables by invoking the function FulfillCondition(S₂, TRUE)

4. The function outputs a solution: #P:$Enabled# and #P:$Visible# require the value TRUE, #P# has to be set at value “x”.

5. The following is now performed for all three variables:

(First loop for #P:$Enabled#):

6. The present value of the variable (FALSE) does not coincide with the required value (TRUE)=>a prior path has to be sought, which sets the variable accordingly

7. A suitable transition is sought

8. A solution is found: T₃ activates P!

9. Recursive invoking of SearchPath To Trans(T₃, Cₛ) to find a path to T₃

Function SearchPath To Trans(T₃, Cₛ)

[Recursion Depth 3]

1. Determine the set of permitted input combinations S₃=#U:$Enabled# AND #U:$Visible# AND #U# !=“”

2. Cₛ ∉ S₃=>a path is necessary

3. Seek suitable values for all variables by invoking the function FulfillCondition(S₃, TRUE)

4. The function outputs a solution: #U:$Enabled# and #U:$Visible# require the value TRUE, #U# has to be set at value “x”.

5. The following is now performed for all three variables:

{

(First loop for #U:$Enabled#):

6. The present value of the variable coincides with the required one=>no prior path is necessary, we continue with the next variable

(Second loop for #U:$Visible#):

6. The present value of the variable coincides with the required one=>no prior path is necessary, we continue with the next variable

(Third loop for #U#):

6. The present value of the variable (“”)does not coincide with the required value (“x”)=>a prior path has to be sought, which sets the variable accordingly

7. A suitable transition is sought

8. A solution is found: input fields enable the direct manipulation of their content by the user. This transition is designated hereafter as Tᵤ.

9. Recursive invoking of SearchPathToTrans(Tᵤ, Cₛ) to find a path to Tᵤ

Function SearchPathToTrans(Tᵤ, Cₛ)

[Recursion Depth 4]

1. Determine the set of valid input combinations Sᵤ=#U:$Enabled# AND #U:$Visible#

2. Cₛ ε Sᵤ=>successful completion

[Recursion Depth 3 Continued]

10. A solution has been found. Solution path=(Tᵤ)

11. Check whether the new path changes any variable that was set in a previous loop.

12. #U:$Enabled# and #U:$Visible# are not changed by the path

13. Add the new path to the outcome path (which is presently empty), set the present status Cᵢ at τᵤ(Cₛ). Since no further variables need to be set, the loop is exited.

}

14. A solution has been found

15. Output of the outcome path

[Recursion Depth 2 Continued]

10. A solution has been found. Solution path=(Tᵤ, T₃)

11. Check whether the new path changes any variable that was set in a previous loop.

12. Since this is the first loop, the path is accepted

13.Add the new path to the outcome path (presently empty), set the present status Cᵢ at τ₃(τᵤ(Cₛ)).

(Second loop for #P:$Visible#):

6. The present value of the variable coincides with the required one=>no prior path is necessary, we continue with the next variable

(Third loop for #P#):

6. The present value of the variable (“”)does not coincide with the required value (“x”)=> a prior path has to be sought, which sets the variable accordingly

7. A suitable transition is sought

8. A solution is found: input fields enable the direct manipulation of their content by the user. This transition is designated hereafter as Tₚ.

9. Recursive invoking of SearchPath To Trans(Tₚ, Cᵢ) to find a path to Tₚ

Function SearchPathToTrans(Tₚ, Cᵢ)

[Recursion Depth 3]

1. Determine the set of valid input combinations Sₚ #P:$Enabled# AND #P:$Visible#

2. Cᵢ ε Sₚ=>successful completion

[Recursion Depth 2 Continued]

10. A solution has been found. Solution path (Tₚ)

11. Check whether the new path changes any variable that was set in a previous loop.

12. #P:$Enabled# and #P:$Visible# remain unchanged by the path

13.Add the new path to the outcome path (Tu, T₃), set the present status Cᵢ at τₚ(τ₃(τᵤ(Cₛ))). Since no more variables are present, the loop is exited.

}

14.A solution has been found

15. Output of the outcome path

[Recursion Depth 1 Continued]

10.A solution has been found. Solution path=(Tᵤ, T₃, Tₚ, T₂)

11. Check whether the new path changes any variable that was set in a previous loop.

12. Since this is the first loop, the path is accepted

13.Add the new path to the outcome path, set the present status Cᵢ at τ₂(τₚ(τ₃(τᵤ(Cₛ))))

(Second loop for #O:$Visible#):

6. The present value of the variable coincides with the required one => no prior path is necessary, we continue with the next variable.

}

14.A solution has been found

15. Output of the outcome path

[Function GenerateTC Continued]

A solution has been found. Solution path P₁=(Tᵤ, T₃, Tₚ, T₂, T₁) Seek the path P₂ by invoking the function

SearchPathToEnd(τ₁(τ₂(τₚ(τ₃(τᵤ(Cₛ))))))

Function SearchPathToEnd(τ₁(τ₂(τₚ(τ₃(τᵤ(Cₛ))))))

Successful completion, since the input combination=Cₑ (the last transition T₁ closes the application)

[Function GenerateTC Continued]

A solution has been found. Solution path P₂=( ) Output of the entire test case=(Tᵤ, T₃, Tₚ, T₂, T₁)

The entire test case is now ready:

1. Enter the username “x”, thereby activating the field “password”

2. Enter the password “x”, thereby activating the OK button

3. Press the OK button, thereby closing the application

Concluding Remarks

As compared to other algorithms for test case generation, the algorithm presented here is much more efficient. For example, there are solutions in existence based on a Prolog algorithm. This algorithm carries out a recursive search for a path which leads to a transition. However, the search is conducted rather aimlessly, which means that correct paths are only found by accident. Furthermore, the recursion depth cannot be restricted by the user, which leads to very long processing time and often even ends in infinite loops. This Prolog-based algorithm is therefore suitable mainly for small, command line-oriented user interfaces in which the number of possible user actions is very limited. However, this method is not suitable for modern GUIs.

In contrast, the present method according to the invention and the software based on it not only automatically determines the necessary values for the GUI, but also attempts to set these values systematically, one after the other. The maximum recursion depth can be controlled by the user, and infinite loops are impossible.

The main strength of the invented method and the algorithm derived from it is that it does not search for random paths, and then check to see whether they solve the given problem, but instead it first determines how a correct solution will appear, and only then searches for a way to find this solution.

1. A method for automated testing of software, which has a graphic user interface, wherein a test case generator software which can be executed on a data processing device is used, by means of which test cases are generated and these are checked with a software [program] for automatic test running on a data processing device, characterized in that
a) using at least one editor at least the dynamic and the semantic behavior of the user interface of the software is specified, the editor used being a graphic editor, and
b) test cases are generated by the test case generator software by means of the thus specified behavior of the user interface and
c) they are then executed directly or in a later step by the software for automatic test running.

2. The method according to claim 1, further characterized in that static information on the user interface is entered by the editor prior to step a).

3. The method according to claim 2, further characterized in that the static information is entered from a resource file.

4. The method according to claim 2, further characterized in that the static information is entered by means of a monitor screen analysis software.

5. The method according to one of claims 2 to 4, further characterized in that the static information comprises at least a layout and/or attribute of the elements of the graphic user interface.

6. The method according to one of claims 2 to 5, further characterized in that the static information is amplified by a user in terms of the layout and/or the attributes.

7. The method according to one of claims 1 to 6, further characterized in that the dynamic behavior of the software/user interface is specified by entering status transitions.

8. The method according to claim 7, further characterized in that the status transitions are represented by graphic symbols.

9. The method according to claim 7 or 8, further characterized in that the status transitions are associated with semantic conditions.

10. The method according to one of claims 7 to 9, further characterized in that the status transitions are associated with syntactical conditions.

11. The method according to one of claims 1 to 10, further characterized in that all elements of the graphic user interface are addressed at least once by the test case generator software.

12. The method according to one of claims 9 to 11, further characterized in that all status transitions dependent upon semantic and/or syntactical conditions are covered by the test case generator software with at least one correct and at least one wrong transition value.

13. A method for testing of software with a graphic user interface (GUI), wherein test cases are checked with a software for automatic test running on a data processing device, which are generated with a test case generator software, wherein to test a transition (Tₙ) between two states (Cₙ, Cₙ₊₁) of the user interface (GUI) of the software being tested at least one test case (TC) is generated, which contains the corresponding transition (Tₙ), characterized in that to generate the at least one test case (TC)
a) a first path (P₁) from transitions (T₁, T₂, . . . Tₙ₌₁) is generated, which starts in a starting state (Cₛ) of the user interface (GUI) and ends in an intermediate state (Cₙ), the intermediate state (Cₙ) being a state which fulfills all necessary input conditions (Cₙ ε Sₙ) for the transition (Tₙ) being checked, and
b) at least one additional path (P₂) from transitions (Tₙ₊₁, Tₙ₊₂, . . . Tₘ) is generated, which begins in the state (Cₙ₊₁) generated by the transition (Tₙ) being tested and ends in the end state (Cₑ) of the graphic user interface (GUI), and
c) the two paths (P₁, P₂) are joined together by the transition (Tₙ).

14. A method according to claim 13, further characterized in that the test case (TC) is stored in a test case database.

15. A method for determining a path (Pₓ) to a given transition in an expanded state diagram, characterized in that
a) at least one set of permitted input conditions (Sₙ) is determined, for which the transition being tested (Tₙ) is executable,
b) suitable values are determined for all variables on which the input conditions (Sₙ) are dependent, so that all input conditions are fulfilled (Sₙ=TRUE), and for each variable on which the condition (Sₙ) is dependent, starting with a first variable
c) at least one transition (Tₓ) is sought, which sets the variable at the desired value, then the state (Cᵢ) of the state diagram is changed to a value corresponding to the value of the altered variable and
d) step c) is carried out for the next variable of condition (Sₙ).

16. The method according to claim 15, further characterized in that the path (Pₓ) is determined by invoking a search function SearchPathToTrans (Tₓ, Cᵢ)).

17. The method according to claim 15 or 16, further characterized in that, if the present status (Cᵢ) of the state diagram coincides with a set of permitted input conditions (Cₙ ε Sₙ), no path (Pₓ) is generated.

18. The method according to one of claims 15 to 17, further characterized in that the variables have a predeterminable sequence and the variables of step c) and d) are worked off in a given sequence.

19. The method according to one of claims 15 to 18, further characterized in that, when the value of one variable coincides with the desired value in step c), the method continues with the next variable.

20. The method according to one of claims 15 to 19, further characterized in that an error is output [when] no suitable values are found in step c).

21. The method according to one of claims 15 to 19, further characterized in that, if no transition (Tₓ) is found for a variable, the method returns at least to the immediately preceding variable, generates a new transition for it, and then seeks another transition for the variable after step c).

22. The method according to one of claims 15 to 21, further characterized in that a path is determined for each transition (Tₓ).

23. Method per claim 22, further characterized in that the path is determined by recursive invoking of the search function (SearchPathToTranse (Tₓ, Cᵢ)).

24. The method according to claim 22 or 23, further characterized in that a different transition (Tₓ′) is determined in the event that no path is found for the transition (Tₓ).

25. The method according to one of claims 22 to 24, further characterized in that, if a path is found, the method checks whether one or more variables already set at a desired value are changed by the path.

26. The method according to claims 25, further characterized in that, if at least one variable is changed by a path, a new path for the transition (Tₓ) is sought.

27. The method according to one of claims 16 to 26, further characterized in that, if a solution is not found, the sequence for working off the variables is modified.

28. The method according to one of claims 16 to 27, further characterized in that, if a solution is not found, different variables are sought in step b).

29. The method according to one of claims 16 to 28, further characterized in that a path when determined is added to an outcome path and the outcome path is output after all paths have been added.

30. The method according to one of claims 16 to 29, further characterized in that, to determine a path, (P₂) to an end state of the status diagram, a transition (T_{y}) is sought, which immediately ends the application, and a path to the transition (T_{y}) is sought starting from a present state (Cₙ₊₁) of the status diagram.

31. The method according to claim 30, further characterized in that, if the present state of the application is the end state (Cₙ₊₁=Cₑ), no path is sought.
